(19) United States
(12) Patent Application Publication
(10) Pub. No.: US 2025/0149258 A1
(43) Pub. Date: May 8, 2025

(54) SOFT START CONTROLLERS FOR MOTORS, AND COMPONENTS OF SOFT START CONTROLLERS

(71) Applicant: International Controls and Measurements Corporation, North Syracuse, NY (US)

(72) Inventor: Eric Christopher WOOD, East Syracuse, NY (US)

(73) Assignee: International Controls and Measurements Corporation, North Syracuse, NY (US)

(21) Appl. No.: 18/937,015

(22) Filed: Nov. 4, 2024

Related U.S. Application Data
(60) Provisional application No. 63/596,816, filed on Nov. 7, 2023.

(51) Int. Cl. H01G 9/145; H01G 9/008; H01G 9/08

(52) U.S. Cl. CPC H01G 9/145; H01G 9/008; H01G 9/08

(57) ABSTRACT

A soft start controller, comprising a PCBA, a soft start capacitor and a soft start controller housing. The soft start capacitor comprises first and second conductive elements, electrolytic fluid, and a capacitor casing. The PCBA and the soft start capacitor are within the soft start controller housing. The soft start capacitor is inside a sub-housing, the PCBA is outside the sub-housing, and the sub-housing prevents said electrolytic fluid from escaping from the sub-housing upon any of said electrolytic fluid escaping from the capacitor casing. Also, a soft start capacitor assembly, comprising a soft start capacitor and an enclosure.

### CROSS-REFERENCE TO RELATED APPLICATIONS

This application claims the benefit under 35 U.S.C. 119 section (e) of U.S. Provisional Patent Application No. 63/596,816, filed Nov. 7, 2023, the entirety of which is incorporated herein by reference.

### FIELD OF THE INVENTION

The present invention relates to electronic components, in particular, to soft start controllers for motors, and components thereof.

### BACKGROUND

There is an ongoing need for electronic components that provide better energy efficiency, reliability and/or safety.

Many motors include soft starters. A soft starter reduces the strain put on an AC motor during the typical power-up phase. A soft starter typically slowly and gradually begins applying increasing voltages to the motor, allowing for a smooth acceleration of power instead of a sudden and violent burst of power that could potentially cause damage to the motor and the machine with which the motor is used. There are different designs for soft starters, many of which include start capacitors.

### BRIEF SUMMARY OF THE INVENTION

This section (i.e., “Brief Summary of the Invention”) presents a simplified summary of the present invention in order to provide a basic understanding of some aspects of the invention. Included in this section are some concepts of the invention as a prelude to more detailed descriptions of aspects of the present invention, and representative embodiments in accordance with aspects of the present invention.

A variety of soft start controllers for motors currently exist, many of which include a capacitor (commonly referred to as a “start capacitor”). A potential failure mode for soft start controllers that include start capacitors is the start capacitor venting and leaking highly conductive electrolytic fluid on a printed circuit board assembly (PCBA) of the soft start controller. The resultant of this failure mode can present a short circuit anywhere on the PCBA, and can lead to a safety critical scenario including damage to the controller, damage to the equipment within which the controller is installed, damage to the home and/or injury.

In accordance with a first aspect of the present invention, there is provided a soft start controller, comprising:
at least a first PCBA;
a soft start capacitor; and
a soft start controller housing,
the soft start capacitor comprising at least first and second conductive elements, electrolytic fluid, and a capacitor casing,
the first and second conductive elements and the electrolytic fluid are within the capacitor casing,
the first PCBA and the soft start capacitor are within the soft start controller housing,
the soft start controller housing comprising a sub-housing,
the soft start capacitor is inside the sub-housing,
the first PCBA is outside the sub-housing, and
the sub-housing prevents said electrolytic fluid from escaping from the sub-housing upon any of said electrolytic fluid escaping from the capacitor casing.

In some embodiments in accordance with the first aspect of the present invention, the first PCBA comprises components of soft start circuitry.

In some embodiments in accordance with the first aspect of the present invention, the soft start capacitor further comprises insulating material between the first and second conductive element, and the insulating material electrically insulates the first conductive element from the second conductive element. In some of such embodiments, the first conductive element, the insulating material and the second conductive element are in the form of a rolled-up sandwich.

In some embodiments in accordance with the first aspect of the present invention:
the soft start capacitor further comprises first and second conductive terminals,
the first conductive terminal is electrically connected to the first conductive element, and
the second conductive terminal is electrically connected to the second conductive element. In some of such embodiments:
each of the first and second conductive terminals extends through the capacitor casing from inside the capacitor casing to outside the capacitor casing; and/or
the soft start controller further comprises a first conductor and a second conductor, the first conductor extends through the sub-housing, and is electrically connected to the first PCBA and to the first conductive terminal, and the second conductor extends through the sub-housing, and is electrically connected to the first PCBA and to the second conductive terminal.

In some embodiments in accordance with the first aspect of the present invention, each of the first and second conductive elements comprises aluminum.

In some embodiments in accordance with the first aspect of the present invention, the soft start capacitor further comprises a plastic shield that electrically insulates the capacitor casing from the first and second conductive elements. In some of such embodiments, the capacitor casing comprises metal.

In some embodiments in accordance with the first aspect of the present invention, the capacitor casing comprises plastic.

In some embodiments in accordance with the first aspect of the present invention, the sub-housing defines an interior space, and an entirely of the sub-housing is devoid of any PCBA.

In accordance with a second aspect of the present invention, there is provided a soft start capacitor assembly, comprising:
a soft start capacitor; and
an enclosure,
the soft start capacitor comprising first and second conductive elements, electrolytic fluid, and a capacitor casing,
the first and second conductive elements and the electrolytic fluid are within the capacitor casing,
the soft start capacitor is within the enclosure, and
the enclosure prevents said electrolytic fluid from escaping from the enclosure upon any of said electrolytic fluid escaping from the capacitor casing.

In some embodiments in accordance with the second aspect of the present invention, the soft start capacitor further comprises insulating material between the first and second conductive element, and the insulating material electrically insulates the first conductive element from the second conductive element. In some of such embodiments, the first conductive element, the insulating material and the second conductive element are in the form of a rolled-up sandwich.

In some embodiments in accordance with the second aspect of the present invention:
the soft start capacitor further comprises first and second conductive terminals,
the first conductive terminal is electrically connected to the first conductive element, and
the second conductive terminal is electrically connected to the second conductive element. In some of such embodiments:
each of the first and second conductive terminals extends through the capacitor casing from inside the capacitor casing to outside the capacitor casing; and/or
the first and second conductive terminals are completely within the sub-housing, a first conductor extends from the first conductive terminal to outside the sub-housing, and a second conductor extends from the second conductive terminal to outside the sub-housing.

In some embodiments in accordance with the second aspect of the present invention, each of the first and second conductive elements comprises aluminum.

In some embodiments in accordance with the second aspect of the present invention, the soft start capacitor further comprises a plastic shield that electrically insulates the capacitor casing from the first and second conductive elements. In some of such embodiments, the capacitor casing comprises metal.

In some embodiments in accordance with the second aspect of the present invention, the capacitor casing comprises plastic.

In some embodiments in accordance with the second aspect of the present invention, the enclosure defines an interior space, and an entirely of the interior space is devoid of any PCBA.

The present invention may be more fully understood with reference to the accompanying drawings and the following detailed description of the invention.

### BRIEF DESCRIPTION OF THE DRAWING FIGURES

FIG. 1 schematically depicts a sectional view of a first embodiment of a soft start controller 10 in accordance with the present invention.

FIG. 2 schematically depicts a sectional view of a second embodiment of a soft start controller 30 in accordance with the present invention.

FIG. 3 schematically depicts a sectional view of a first embodiment of a soft start capacitor assembly 40 in accordance with the present invention.

### DETAILED DESCRIPTION OF THE INVENTION

The expression “invention” is used herein to refer to any portion (or portions) of the inventive subject matter disclosed herein. As described herein, the present invention includes many aspects.

The expression “comprises” or “comprising,” is used herein in accordance with its well known usage, and means that the item that “comprises” the recited elements (or that is “comprising” the recited elements) includes at least the recited elements, and can optionally include any additional elements. For example, an item that “comprises at least a first PCBA, a soft start capacitor, and a soft start controller housing” includes at least one PCBA, at least one soft start capacitor, and at least one soft start controller housing, i.e., it can include a single PCBA or a plurality of (two or more) PCBAs (and likewise can include a single soft start capacitor or a plurality of soft start capacitors, and can include a single soft start controller housing or a plurality of soft start controller housings, etc.), and may further comprise any number of each of one or more items that is/are not recited. An item that comprises at least first and second recited elements can include the two recited elements or can include three or more of the recited elements (e.g., a soft start capacitor comprising at least first and second conductive elements comprises the first and second conductive elements and may comprise any number of additional conductive elements.

The expression “embodiment,” as used herein, means an embodiment in accordance with the present invention, i.e., an embodiment that is encompassed within the present inventive subject matter.

Where an expression is defined herein in terms of the meaning of the expression in the singular, the definition applies also to the plural (and vice-versa, i.e., for an expression defined herein in the plural, the definition applies also to the singular). Definitions of one form of an expression apply to the same expression in a different form of the word or words. As used herein, the singular forms “a”, “an” and “the” are intended to include the plural forms as well, unless the context clearly indicates otherwise.

Although the terms “first”, “second”, etc. may be used herein to describe various elements herein (e.g., “first and second conductive elements,” “first and second conductive terminals,” and “first and second conductors,”), such elements are not limited by these terms. These terms are only used to distinguish one of a type of element from another of a type of the same or similar element. Thus, a first conductive element discussed herein could instead be termed a second conductive element (and vice-versa) without departing from the teachings of the present inventive subject matter.

The expression “conductive,” as used herein, means that the element or structure that is described as being “conductive” is configured to carry electrical current (e.g., it could be a wire, a wire bond, a trace, a thin metallic structure that has a large surface area, such as a metal plate (which can be planar or curved), etc.).

The expression “conductor,” as used herein, refers to an element or structure that is configured to carry electrical current (e.g., it could be a wire, a wire bond, a trace, a thin metallic structure that has a large surface area, such as a metal plate (which can be planar or curved), etc.).

A statement herein that two (or more) components in a device are “electrically connected,” means that there are no components electrically between the components that affect the function or functions provided by the device. For example, two components can be referred to as being electrically connected, even though they may have a small resistor between them which does not materially affect the function or functions provided by the device (indeed, a wire connecting two components can be thought of as a small resistor); likewise, two components can be referred to as being electrically connected, even though they may have an additional electrical component (or plural additional electrical components) between them which allows the device to perform an additional function, while not materially affecting the function or functions provided by a device which is identical except for not including the additional component; similarly, two components which are directly connected to each other, or which are directly connected to opposite ends of a wire or a trace on a circuit board, are electrically connected. In addition, “electrically connected” also encompasses situations where two (or more) components are “directly electrically connected,” as defined herein. Thus, the expression “electrically connected,” as used herein, means that the items that are described as being electrically connected to each other are directly electrically connected to each other, or are both in a sequence of items that are directly electrically connected to each other via one or more intervening items that are each directly connected to other items in the sequence. For example, where a first electrically conductive item is directly electrically connected to a second (intervening) electrically conductive item (at a first location of the second electrically conductive item), and the second electrically conductive item is (at a second location of the second electrically conductive item) directly electrically connected to a third electrically conductive item, the first electrically conductive item and the third electrically conductive item are “electrically connected” to each other (and they are “in electrical connection” with each other).

The expression “the sub-housing prevents said electrolytic fluid from escaping from the sub-housing upon any of said electrolytic fluid escaping from the capacitor casing,” as used herein, is not overly idealized, i.e., it does not exclude the possibility of a minor amount of electrolytic fluid from escaping from the sub-housing. Thus, the expression “the sub-housing prevents said electrolytic fluid from escaping from the sub-housing upon any of said electrolytic fluid escaping from the capacitor casing” encompasses where no electrolytic fluid escapes, but also encompasses where only 1% by mass of the electrolytic fluid that escapes from the capacitor casing escapes from the sub-housing over the course of one month, and in some instances encompasses where only 2% by mass (and in some cases, 3%, 4% or 5%, by mass) of the electrolytic fluid that escapes from the capacitor casing escapes from the sub-housing over the course of one month.

The expression “in the form of a rolled-up sandwich,” as used herein, encompasses what would be obtained where an insulating material is positioned between first and second conductive elements (to form a sandwich) such that the first and second conductive elements are electrically insulated from one another, and the sandwich is curled to at least some degree (including being rolled to the extent that there exists an imaginary line passing through the rolled-up sandwich that extends through each of the conductive elements and the insulating material multiple times, and in some cases, many times (e.g., 10 times or more), to provide a first and second conductive elements of large surface areas in a shape whose largest dimension is much smaller than the dimensions of the conductive elements prior to rolling them up.

The expression “insulating material” is used herein in accordance with its well known meaning, to refer to a material that prevents electrical conductivity (in this case, between the first and second conductive elements) to an extent that those of skill in the art would consider insulating (i.e., not in an overly idealized sense).

Unless otherwise defined, all terms (including technical and scientific terms) used herein have the same meaning as commonly understood by one of ordinary skill in the art to which this invention belongs. Terms and expressions, such as those defined in commonly used dictionaries, should each be interpreted as having a meaning that is consistent with their meaning in the context of the relevant art and the present disclosure, and not in an idealized or overly formal sense (unless expressly so defined herein).

As noted above, the present invention provides soft start controllers that each comprise at least a first PCBA, a soft start capacitor (comprising conductive elements, electrolytic fluid, and a casing) and a soft start controller housing, as well as soft start capacitor assemblies that each comprise a soft start capacitor and an enclosure.

Those of skill in the art are familiar with a wide variety of PCBAs that comprise components of soft start circuitry, and any of such PCBAs can be employed in soft start controllers in accordance with the present invention.

Those of skill in the art are familiar with a wide variety of conductive elements, and electrolytic fluids that are suitable for use in making soft start capacitors, and any of such conductive elements and electrolytic fluids can be employed in soft start controllers and soft start capacitor assemblies in accordance with the present invention.

Those of skill in the art are familiar with a wide variety of materials out of which a casing for a soft start capacitor can be made. Any of such materials can be used to make casings for soft start capacitors employed in soft start controllers and soft start capacitor assemblies in accordance with the present invention, and such casings can be made in any suitable shapes and sizes.

Those of skill in the art are familiar with a wide variety of materials out of which a soft start controller housing can be made. Any of such materials can be used to make soft start controller housings employed in soft start controllers in accordance with the present invention, and such housings can be made in any suitable shapes and sizes.

As noted above, the present invention provides soft start controllers that each comprise a soft start controller housing that comprises a sub-housing, and soft start capacitor assemblies that each comprise an enclosure. The soft start controller housings, the sub-housings and the enclosures can be made of any suitable material (or materials), and can be of any suitable shape and size.

Those of skill in the art are familiar with a wide variety of insulating materials that can be used to insulate conductive elements from each other, and any of such insulating materials can be employed in soft start capacitors in accordance with the present invention that comprise insulating materials.

Those of skill in the art are familiar with a wide variety of conductive terminals that are suitable for use in making soft start capacitors, and any of such conductive terminals can be employed in soft start capacitors in accordance with the present invention that comprise conductive terminals.

Those of skill in the art are also familiar with plastic shields for electrically insulating capacitor casings from conductive elements, and any such plastic shields can be employed in embodiments that comprise plastic shields.

Detailed descriptions of embodiments that correspond to the present invention (and/or aspects of the present invention), and detailed descriptions of features that are provided in some embodiments in accordance with the present invention, are provided hereinafter, in many instances with reference to the accompanying drawings, in which representative embodiments in accordance with the present invention are shown. These detailed descriptions of specific aspects of the present invention, and embodiments in accordance with the present invention, are provided to describe features of the present invention with reference to a specific embodiment or embodiments. The present invention should not be construed as being limited to the specific features in the embodiments set forth herein. That is, every statement about an embodiment described herein is to be interpreted as being prefaced with “In this embodiment, . . . ”

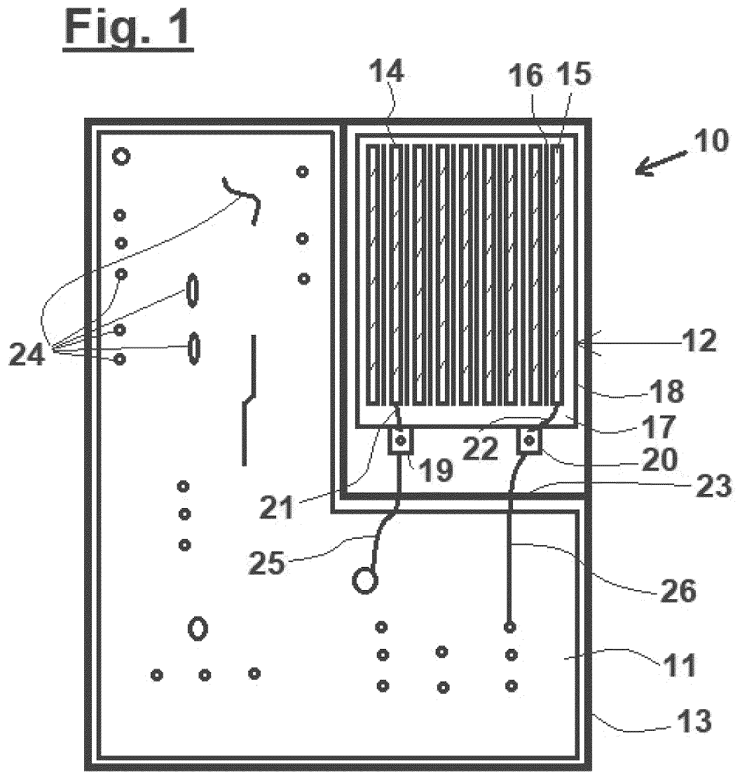

FIG. 1 schematically depicts a sectional view of a first embodiment of a soft start controller 10 in accordance with the present invention. The soft start controller 10 comprises a PCBA 11, a soft start capacitor 12, and a soft start controller housing 13.

The soft start capacitor 12 comprises a first conductive element 14, a second conductive element 15, insulating material 16 between the first conductive element 14 and the second conductive element 15, electrolytic fluid 17, a capacitor casing 18, a first conductive terminal 19 and a second conductive terminal 20.

The insulating material 16 electrically insulates the first conductive element 14 from the second conductive element 15, and the first conductive element 14, the insulating material 16 and the second conductive element 15 are in the form of a rolled-up sandwich.

The first conductive terminal 19 further comprises a first conductor (in the form of a wire 21) which is electrically connected to the first conductive element 14, and the second conductive terminal 20 further comprises a second conductor (in the form of a wire 22) which is electrically connected to the second conductive element 15.

The PCBA 11 and the soft start capacitor 12 are within the soft start controller housing 13.

The soft start controller housing 13 comprises a sub-housing 23.

The soft start capacitor 12 is inside the sub-housing 23, the PCBA 11 is outside the sub-housing 23, and the sub-housing 23 prevents the electrolytic fluid 17 from escaping from the sub-housing 23 upon any of said electrolytic fluid 17 escaping from the capacitor casing 18.

The PCBA 11 comprises components 24 of soft start circuitry.

The first conductive terminal 19 and the second conductive terminal 20 are completely within the sub-housing 23, a third conductor (in the form of a wire 25) extends from the first conductive terminal 19 to the PCBA 11 (outside the sub-housing 23), and a fourth conductor (in the form of a wire 26) extends from the second conductive terminal 20 to the PCBA 11 (also outside the sub-housing 23).

Each of the first conductive element 14 and the second conductive element 15 comprises aluminum.

The sub-housing 23 defines an interior space, and an entirely of the interior space is devoid of any PCBA.

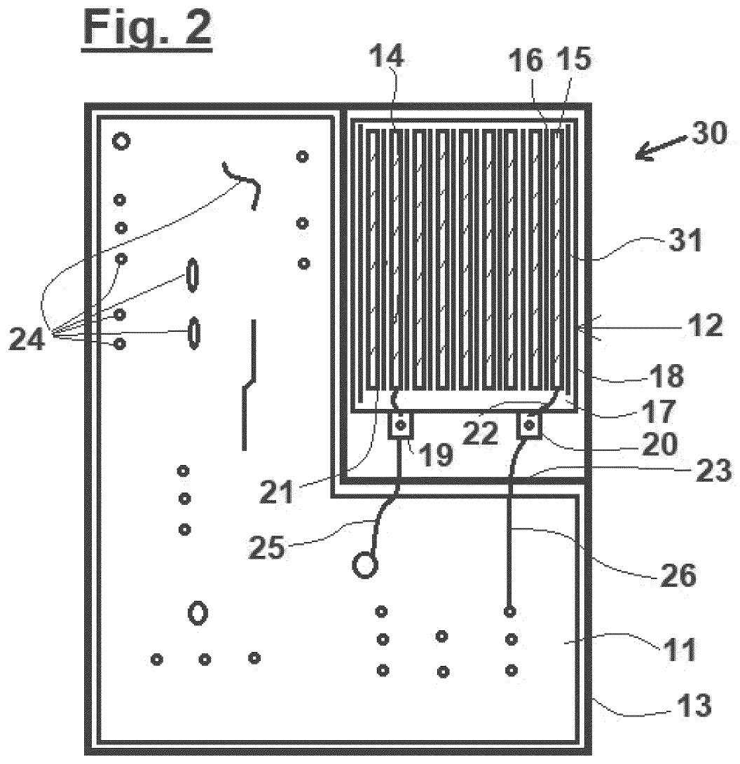

FIG. 2 schematically depicts a sectional view of a second embodiment of a soft start controller 30 in accordance with the present invention. The soft start controller 30 is similar to the soft start controller 10, except that the soft start controller further comprises a plastic shield 31 that electrically insulates the capacitor casing 18 (which comprises metal in this embodiment) from the first and second conductive elements 14 and 15.

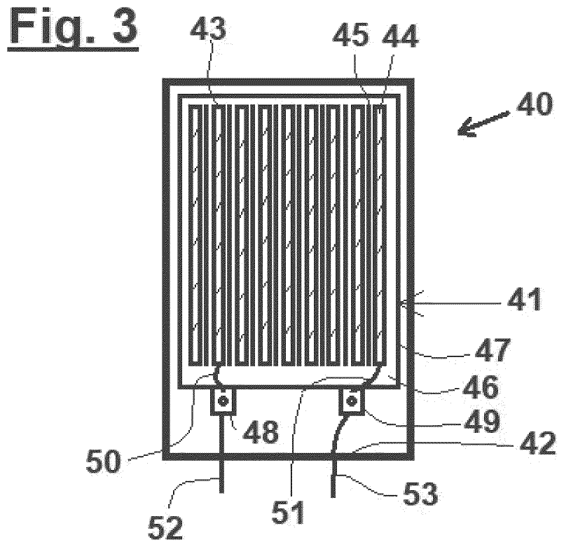

FIG. 3 schematically depicts a sectional view of a first embodiment of a soft start capacitor assembly 40 in accordance with the present invention. The soft start capacitor assembly 40 comprises a soft start capacitor 41 and an enclosure 42. The soft start capacitor 41 comprises a first conductive element 43, a second conductive element 44, insulating material 45 between the first conductive element 43 and the second conductive element 44, electrolytic fluid 46, a capacitor casing 47, a first conductive terminal 48, and a second conductive terminal 49.

The insulating material 45 electrically insulates the first conductive element 43 from the second conductive element 44, and the first conductive element 43, the insulating material 45 and the second conductive element 44 are in the form of a rolled-up sandwich.

The first conductive terminal 48 further comprises a first conductor (in the form of a wire 50) which is electrically connected to the first conductive element 43, and the second conductive terminal 49 further comprises a second conductor (in the form of a wire 51) which is electrically connected to the second conductive element 44.

The first conductive element 43, the second conductive element 44, the insulating material 45 and the electrolytic fluid 46 are within the capacitor casing 47.

The soft start capacitor 41 is within the enclosure 42, and the enclosure 42 prevents the electrolytic fluid 46 from escaping from the enclosure 42 upon any of said electrolytic fluid 46 escaping from the capacitor casing 47.

The first conductive terminal 48 and the second conductive terminal 49 are completely within the enclosure 42, a third conductor (in the form of a wire 52) extends from the first conductive terminal 48 to outside the enclosure 42, and a fourth conductor (in the form of a wire 53) extends from the second conductive terminal 49 to outside the enclosure 42.

The enclosure 42 defines an interior space, and an entirely of the interior space is devoid of any PCBA.

Any two or more structural parts of the soft start controllers and the soft start capacitor assemblies described herein can be integrated. Any structural part of the soft start controllers and the soft start capacitor assemblies described herein can be provided in two or more parts. Similarly, any two or more functions can be conducted simultaneously, and/or any function can be conducted in a series of steps.

Furthermore, while certain embodiments of the present invention have been illustrated with reference to specific combinations of elements and attributes, various other combinations may also be provided without departing from the teachings of the present invention. Thus, the present invention should not be construed as being limited to the particular exemplary embodiments described herein and illustrated in the Figures, but may also encompass combinations of elements and attributes of the various illustrated embodiments.

Based on the information provided in the present disclosure, many alterations and modifications may be made by those having ordinary skill in the art, given the benefit of the present disclosure, without departing from the teaching of the present specification, and/or without departing from the spirit and scope of the present invention.

1. A soft start controller, comprising:
at least a first PCBA;
a soft start capacitor; and
a soft start controller housing,
the soft start capacitor comprising at least first and second conductive elements, electrolytic fluid, and a capacitor casing,
the first and second conductive elements and the electrolytic fluid are within the capacitor casing,
the first PCBA and the soft start capacitor are within the soft start controller housing,
the soft start controller housing comprising a sub-housing,
the soft start capacitor is inside the sub-housing,
the first PCBA is outside the sub-housing, and
the sub-housing prevents said electrolytic fluid from escaping from the sub-housing upon any of said electrolytic fluid escaping from the capacitor casing.

2. The soft start controller recited in claim 1, wherein:
the soft start capacitor further comprises insulating material between the first and second conductive elements, and
the insulating material electrically insulates the first conductive element from the second conductive element.

3. The soft start controller recited in claim 2, wherein the first conductive element, the insulating material and the second conductive element are in the form of a rolled-up sandwich.

4. The soft start controller recited in claim 1, wherein the soft start capacitor further comprises at least first and second conductive terminals,
the first conductive terminal is electrically connected to the first conductive element, and
the second conductive terminal is electrically connected to the second conductive element.

5. The soft start controller recited in claim 4, wherein each of the first and second conductive terminals extends through the capacitor casing from inside the capacitor casing to outside the capacitor casing.

6. The soft start controller recited in claim 4, wherein:
the first and second conductive terminals are completely within the sub-housing,
a first conductor extends from the first conductive terminal to outside the sub-housing, and
a second conductor extends from the second conductive terminal to outside the sub-housing.

7. The soft start controller recited in claim 1, wherein:
the soft start controller further comprises a first conductor and a second conductor,
the first conductor extends from the first PCBA, through the sub-housing, and is electrically connected to the first conductive element, and
the second conductor extends from the first PCBA, through the sub-housing, and is electrically connected to the second conductive element.

8. The soft start controller recited in claim 1, wherein the first PCBA comprises components of soft start circuitry.

9. The soft start controller recited in claim 1, wherein each of the first and second conductive elements comprises aluminum.

10. The soft start controller recited in claim 1, wherein the soft start capacitor further comprises a plastic shield that electrically insulates the capacitor casing from the first and second conductive elements.

11. The soft start controller recited in claim 10, wherein the capacitor casing comprises metal.

12. The soft start controller recited in claim 1, wherein the capacitor casing comprises plastic.

13. A soft start capacitor assembly, comprising:
a soft start capacitor; and
an enclosure,
the soft start capacitor comprising first and second conductive elements, electrolytic fluid, and a capacitor casing,
the first and second conductive elements and the electrolytic fluid are within the capacitor casing,
the soft start capacitor is within the enclosure, and
the enclosure prevents said electrolytic fluid from escaping from the enclosure upon any of said electrolytic fluid escaping from the capacitor casing.

14. The soft start controller recited in claim 13, wherein:
the soft start capacitor further comprises insulating material between the first and second conductive elements, and
the insulating material electrically insulates the first conductive element from the second conductive element.

15. The soft start controller recited in claim 14, wherein the first conductive element, the insulating material and the second conductive element are in the form of a rolled-up sandwich.

16. The soft start controller recited in claim 13, wherein the soft start capacitor further comprises at least first and second conductive terminals,
the first conductive terminal is electrically connected to the first conductive element, and
the second conductive terminal is electrically connected to the second conductive element.

17. The soft start capacitor assembly recited in claim 16, wherein each of the first and second conductive terminals extends through the capacitor casing from inside the capacitor casing to outside the capacitor casing.

18. The soft start capacitor assembly recited in claim 16, wherein:
the first and second conductive terminals are completely within the enclosure, a first conductor extends from the first conductive terminal to outside the enclosure, and
a second conductor extends from the second conductive terminal to outside the enclosure.

19. The soft start capacitor assembly recited in claim 13, wherein each of the first and second conductive elements comprises aluminum.

20. The soft start capacitor assembly recited in claim 13, wherein the soft start capacitor further comprises a plastic shield that electrically insulates the capacitor casing from the first and second conductive elements.

21. The soft start capacitor assembly recited in claim 20, wherein the capacitor casing comprises metal.

22. The soft start capacitor assembly recited in claim 13, wherein the capacitor casing comprises plastic.

23. The soft start capacitor assembly recited in claim 13, wherein:
the enclosure defines an interior space, and
an entirely of the interior space is devoid of any PCBA.
